(19) United States
(12) Patent Application Publication
(10) Pub. No.: US 2025/0008533 A1
(43) Pub. Date: Jan. 2, 2025

(54) METHOD AND APPARATUS FOR SIDELINK CARRIER SELECTION

(71) Applicant: Telefonaktiebolaget LM Ericsson (publ), Stockholm (SE)

(72) Inventors: Zhang ZHANG, Beijing (CN); Antonino ORSINO, Kirkkonummi (FI); Nithin SRINIVASAN, Köln (DE); Min WANG, Luleå (SE)

(21) Appl. No.: 18/711,545

(22) PCT Filed: Oct. 11, 2022
(86) PCT No.: PCT/CN2022/124623

§ 371 Date: May 17, 2024

(30) Foreign Application Priority Data
Nov. 19, 2021 (WO) PCT/CN2021/131874

(51) Int. Cl. H04W 72/25; H04W 74/0808

(52) U.S. Cl. CPC H04W 72/25; H04W 74/0808

(57) ABSTRACT

Various embodiments of the present disclosure provide a method for sidelink carrier selection. The method which may be performed by a first user equipment includes: determining, among a set of sidelink carriers configured to the first user equipment, one or more carriers for a sidelink transmission, based on carrier selection performed by the first user equipment itself or according to an instruction from a base station. In accordance with an exemplary embodiment, the method further includes: performing the sidelink transmission to a second user equipment on the one or more carriers determined for the sidelink transmission.

### FIELD OF THE INVENTION

The present disclosure generally relates to communication networks, and more specifically, to a method and apparatus for sidelink (SL) carrier selection.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

D2D communications (also referred to as SL communications or communications over PC5 interface) between neighboring devices are specified by the 3rd generation partnership project (3GPP) in Release-12 (Rel-12). Some enhancements of the SL are introduced in subsequent releases for vehicle-to-vehicle (V2V) or V2X communications. In a wireless communication network supporting SL communications, a V2X capable UE may act as a relay UE which can provide the functionality to support connectivity to the network for another UE that may be out of cell coverage and may not be able to connect with the network directly. In some cases, a UE may communicate with another UE directly or via one or more relay UEs.

Carrier aggregation (CA) is a technique that may be used in wireless communication to increase the bandwidth, and thereby increase the bitrate. Each aggregated carrier may be referred to as a component carrier (CC). When CA is used, a UE may be configured with a number of serving cells, e.g., including a primary cell (PCell) and one or more secondary cells (SCells), one for each component carrier. The coverage of the serving cells may differ, for example due to that CCs on different frequency bands may experience different pathloss.

In an LTE network supporting V2X communication, it may be possible to apply CA for an SL transmission of a UE. For example, the UE may use one or more carriers selected by itself or by a serving base station of the UE to perform the SL transmission. In some cases, carrier (re-) selection may be triggered for the SL transmission of the UE due to various reasons, e.g., there is no available grant or the channel is busy, etc. However, there is no existing solution of carrier (re-) selection for NR SL in case of CA. In addition, considering more capabilities and use cases being supported for NR SL compared to LTE SL, simply applying the carrier (re-) selection mechanism for LTE SL to a SL UE in NR may not achieve optimal performance for NR SL transmission. Therefore, it may be desirable to implement carrier (re-) selection for NR SL in case of multiple carriers such as CA in a more efficient way.

Various exemplary embodiments of the present disclosure propose a solution for SL carrier selection, which may enable one or more carriers (e.g., one or more transmitter (TX) carriers, etc.) to be selected or reselected for an SL transmission of a UE supporting multiple carriers (e.g., CA in NR, etc.).

It can be appreciated that the term “carrier selection” described in this document may refer to initial carrier selection (e.g., for the case that no carrier has been selected or is being used for an SL transmission) and/or carrier reselection (e.g., for the case that a carrier has been selected and is being used for an SL transmission). Thus, the terms “carrier selection” and “carrier (re-) selection” may be used interchangeably in this document.

It can be appreciated that a link or a radio link over which signals are transmitted between at least two UEs for D2D operations may be called in this document as SL. The signals transmitted between the UEs for D2D operations may be called in this document as SL signals. The terms “sidelink” and “SL” may also interchangeably be called as D2D link, V2X link, ProSe link, peer-to-peer link, PC5 link, etc. The SL signals may also interchangeably be called as V2X signals, D2D signals, ProSe signals, PC5 signals, peer-to-peer signals, etc.

According to a first aspect of the present disclosure, there is provided a method performed by a first UE. The method comprises: determining, among a set of SL carriers configured to the first UE, one or more carriers for an SL transmission, based on carrier selection performed by the first UE itself or according to an instruction from a base station. In accordance with an exemplary embodiment, the method further comprises: performing the SL transmission to a second UE on the one or more carriers determined for the SL transmission.

In accordance with an exemplary embodiment, the carrier selection may be triggered for an SL carrier and/or an SL logical channel (LCH), when one or more of the following triggering events occur:
there is no grant or resource available on any SL carrier allowed for the SL LCH;
there is a grant available on the SL carrier while a pool of resources where the grant is obtained is reconfigured by an upper layer;
a number of SL carriers with an available grant is less than a maximum number of SL carriers which the first UE is able to use simultaneously for the SL transmission;
a grant for the SL carrier is obtained according to random resource selection or a sensing result provided by another UE;
a measurement result or historic statistic of the SL carrier indicates that one or more metrics of the SL carrier do not meet one or more performance requirements;
no data or signaling is received during a first period of time on the SL carrier;
no response is received on the SL carrier within a second period of time after data or signaling is sent on the SL carrier;
a last transmission among one or more transmissions of a medium access control (MAC) protocol data unit (PDU) has been performed on the SL carrier for which a grant corresponding to the one or more transmissions of the MAC PDU is obtained; and
a time difference between resources obtained across a number of SL carriers exceeds a packet delay budget (PDB) or a predefined threshold.

In accordance with an exemplary embodiment, the triggering events, and/or metrics, parameters, thresholds and/or performance requirements associated with the triggering events may be configured differently for different services, different LCHs, different carriers, and/or different cast types.

In accordance with an exemplary embodiment, when the carrier selection is triggered, the method according to the first aspect of the present disclosure may further comprise one or more of:
determining to continuously use one or more SL carriers which have already been selected;
determining to select one or more other SL carriers to replace one or more SL carriers which have already been selected; and
selecting one or more candidate carriers from the set of SL carriers configured to the first UE.

In accordance with an exemplary embodiment, the one or more carriers determined for the SL transmission may be selected by the first UE from the one or more candidate carriers according to a priority of the one or more candidate carriers.

In accordance with an exemplary embodiment, the priority of a candidate carrier may be determined based at least in part on one or more of:
channel quality of an SL between the first UE and the second UE on the candidate carrier;
a frequency region of the candidate carrier;
a congestion status of the SL between the first UE and the second UE on the candidate carrier; and
a priority order provided by the base station.

In accordance with an exemplary embodiment, the channel quality and/or the congestion status of the SL between the first UE and the second UE on the candidate carrier may be determined by the first UE based at least in part on one or more of:
performance information of one or more SL transmissions from the first UE to the second UE on the candidate carrier; and
performance information of one or more SL transmissions from the second UE to the first UE on the candidate carrier.

In accordance with an exemplary embodiment, the method according to the first aspect of the present disclosure may further comprise: transmitting SL carrier related information to the base station. In an embodiment, the SL carrier related information may be transmitted to the base station periodically and/or in an event trigger fashion.

In accordance with an exemplary embodiment, the SL carrier related information may comprise one or more of:
one or more indices of one or more carriers and/or candidate carriers which the first UE has selected;
information about one or more LCHs and/or one or more services and/or one or more traffic types which have data available for the SL transmission;
one or more indices of one or more SL carriers for which one or more triggering events occur;
a priority order of the one or more SL carriers; and
measurement information of the one or more SL carriers.

In accordance with an exemplary embodiment, the method according to the first aspect of the present disclosure may further comprise: receiving carrier selection related information from the base station. In an embodiment, the carrier selection related information may be determined by the base station according to the SL carrier related information.

In accordance with an exemplary embodiment, the carrier selection related information may comprise one or more of:
a confirmation of one or more carriers and/or candidate carriers which the first UE has selected;
an instruction of that the first UE needs to select one or more carriers for the SL transmission from a list of carriers and/or candidate carriers provided by the base station;
an indicator indicating whether the first UE needs to perform the carrier selection by itself or follow the instruction from the base station; and
information indicating one or more triggering events for one or more carriers, where the first UE is able to perform the carrier selection based on the one or more indicated triggering events.

In accordance with an exemplary embodiment, the indicator may be received by the first UE per triggering event, per LCH or per service.

In accordance with an exemplary embodiment, the method according to the first aspect of the present disclosure may further comprise: transmitting carrier information related to the SL transmission to the second UE.

In accordance with an exemplary embodiment, the carrier information related to the SL transmission may indicate a list of carriers allowed for an SL LCH of the SL transmission.

In accordance with an exemplary embodiment, the method according to the first aspect of the present disclosure may further comprise: receiving a message from the second UE. In an embodiment, the message may indicate whether the second UE accepts or refuses the list of carriers allowed for the SL LCH.

In accordance with an exemplary embodiment, when the message indicates that the second UE refuses the list of carriers allowed for the SL LCH, the method according to the first aspect of the present disclosure may further comprise: using one or more default carriers or another list of carriers agreed by the first UE and the second UE for the SL LCH.

In accordance with an exemplary embodiment, the carrier information related to the SL transmission may comprise information about the carrier selection.

In accordance with an exemplary embodiment, the information about the carrier selection may indicate one or more of:
whether the first UE is currently performing or going to perform the carrier selection for an SL LCH of the SL transmission; and
one or more carriers determined for the SL LCH by the first UE.

In accordance with an exemplary embodiment, the set of SL carriers configured to the first UE may include a first carrier. In an embodiment, the first carrier may have a highest priority among the set of SL carriers configured to the first UE, so that the first carrier may be preferred to be used for communication between the first UE and the second UE.

In accordance with an exemplary embodiment, the first carrier may be selected in a static or semi-static manner.

In accordance with an exemplary embodiment, the method according to the first aspect of the present disclosure may further comprise: transmitting information about the first carrier and/or a change of the first carrier to the second UE.

In accordance with an exemplary embodiment, the set of SL carriers configured to the first UE may further include one or more second carriers. In an embodiment, compared to the first carrier, the one or more second carriers may have a lower priority and may not be mandatory to be used for the communication between the first UE and the second UE.

In accordance with an exemplary embodiment, the one or more second carriers may be selected in a static, semi-static or dynamic manner.

According to a second aspect of the present disclosure, there is provided an apparatus which may be implemented as a first UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a first UE. The apparatus may comprise a determining unit and a performing unit. In accordance with some exemplary embodiments, the determining unit may be operable to carry out at least the determining step of the method according to the first aspect of the present disclosure. The performing unit may be operable to carry out at least the performing step of the method according to the first aspect of the present disclosure.

According to a fifth aspect of the present disclosure, there is provided a method performed by a second UE. The method comprises: receiving carrier information related to an SL transmission from a first UE. In accordance with an exemplary embodiment, the method further comprises: determining one or more carriers on which the second UE is to receive data carried in the SL transmission from the first UE, according to the carrier information related to the SL transmission.

In accordance with an exemplary embodiment, the carrier information related to the SL transmission may indicate a list of carriers allowed for an SL LCH of the SL transmission.

In accordance with an exemplary embodiment, the method according to the fifth aspect of the present disclosure may further comprise: transmitting a message to the first UE. In an embodiment, the message may indicate whether the second UE accepts or refuses the list of carriers allowed for the SL LCH.

In accordance with an exemplary embodiment, when the second UE accepts the list of carriers allowed for the SL LCH, the one or more carriers on which the second UE is to receive the data carried in the SL transmission from the first UE may be the list of carriers allowed for the SL LCH.

In accordance with an exemplary embodiment, when the second UE refuses the list of carriers allowed for the SL LCH, the one or more carriers on which the second UE is to receive the data carried in the SL transmission from the first UE may be one or more default carriers or another list of carriers agreed by the first UE and the second UE for the SL LCH.

In accordance with an exemplary embodiment, the carrier information related to the SL transmission may comprise information about carrier selection.

In accordance with an exemplary embodiment, the information about the carrier selection may indicate whether the first UE is currently performing or going to perform the carrier selection for an SL LCH of the SL transmission. Alternatively or additionally, the information about the carrier selection may indicate one or more carriers determined for the SL LCH by the first UE.

In accordance with an exemplary embodiment, the method according to the fifth aspect of the present disclosure may further comprise: determining whether the first UE is currently performing or going to perform the carrier selection for an SL LCH of the SL transmission, according to the information about the carrier selection and/or by determining whether one or more triggering events for any carrier occur for the SL LCH.

In accordance with an exemplary embodiment, when the second UE determines that the first UE is currently performing or going to perform the carrier selection for the SL LCH, the one or more carriers on which the second UE is to receive the data carried in the SL transmission from the first UE may be a list of carriers allowed for the SL LCH.

In accordance with an exemplary embodiment, when the second UE determines that the first UE is not performing or not going to perform the carrier selection for the SL LCH, the one or more carriers on which the second UE is to receive the data carried in the SL transmission from the first UE may be one or more carriers which are determined for the SL LCH by the first UE and indicated by the information about the carrier selection.

In accordance with an exemplary embodiment, the method according to the fifth aspect of the present disclosure may further comprise: receiving information about a first carrier and/or a change of the first carrier from the first UE. In an embodiment, the first carrier may have a highest priority among a set of SL carriers configured to the first UE, so that the first carrier may be preferred to be used for communication between the first UE and the second UE.

In accordance with an exemplary embodiment, the set of SL carriers configured to the first UE may further include one or more second carriers. In an embodiment, compared to the first carrier, the one or more second carriers may have a lower priority and may not be mandatory to be used for the communication between the first UE and the second UE.

In accordance with an exemplary embodiment, the first carrier may be selected in a static or semi-static manner. In accordance with another exemplary embodiment, the one or more second carriers may be selected in a static, semi-static or dynamic manner.

According to a sixth aspect of the present disclosure, there is provided an apparatus which may be implemented as a second UE. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a second UE. The apparatus may comprise a receiving unit and a determining unit. In accordance with some exemplary embodiments, the receiving unit may be operable to carry out at least the receiving step of the method according to the fifth aspect of the present disclosure. The determining unit may be operable to carry out at least the determining step of the method according to the fifth aspect of the present disclosure.

According to a ninth aspect of the present disclosure, there is provided a method performed by a base station. The method comprises: receiving SL carrier related information from a UE. In accordance with an exemplary embodiment, the method further comprises: transmitting, to the UE, carrier selection related information which may be determined by the base station according to the SL carrier related information. In an embodiment, the carrier selection related information may be used by the UE to determine, among a set of SL carriers configured to the UE, one or more carriers for an SL transmission.

In accordance with an exemplary embodiment, the SL carrier related information may be received by the base station periodically and/or in an event trigger fashion.

In accordance with an exemplary embodiment, the SL carrier related information received by the base station according to the ninth aspect of the present disclosure may correspond to the SL carrier related information transmitted by the first UE according to the first aspect of the present disclosure. Thus, the SL carrier related information as described according to the first and ninth aspects of the present disclosure may have the same or similar contents and/or feature elements.

Similarly, in accordance with an exemplary embodiment, the carrier selection related information transmitted by the base station according to the ninth aspect of the present disclosure may correspond to the carrier selection related information received by the first UE according to the first aspect of the present disclosure. Thus, the carrier selection related information as described according to the first and ninth aspects of the present disclosure may have the same or similar contents and/or feature elements.

According to a tenth aspect of the present disclosure, there is provided an apparatus which may be implemented as a base station. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a base station. The apparatus may comprise a receiving unit and a transmitting unit. In accordance with some exemplary embodiments, the receiving unit may be operable to carry out at least the receiving step of the method according to the ninth aspect of the present disclosure. The transmitting unit may be operable to carry out at least the transmitting step of the method according to the ninth aspect of the present disclosure.

According to a thirteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the ninth aspect of the present disclosure.

According to a fourteenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the ninth aspect of the present disclosure.

According to a fifteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first or fifth aspect of the present disclosure.

According to a sixteenth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first or fifth aspect of the present disclosure.

According to a seventeenth aspect of the present disclosure, there is provided a method implemented in a communication system which may include a host computer, a base station and a UE. The method may comprise, at the host computer, receiving user data transmitted to the base station from the UE which may perform any step of the method according to the first or fifth aspect of the present disclosure.

According to an eighteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first or fifth aspect of the present disclosure.

According to a nineteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the ninth aspect of the present disclosure.

According to a twentieth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the ninth aspect of the present disclosure.

According to various exemplary embodiments, one or more SL carriers among all SL carriers configured to a UE may be selected for an SL transmission by the UE itself and/or according to signaling from a base station. This can make SL carrier selection more flexible and effective. In addition, the implementation of adaptive SL carrier selection with multiple carriers can save the power of the UE with satisfied quality of service (QOS).

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIGS. 1-3 are flowcharts illustrating various methods according to some embodiments of the present disclosure;

FIG. 4 is a block diagram illustrating an exemplary apparatus according to an embodiment of the present disclosure;

FIGS. 5A-5B are block diagrams illustrating various apparatuses according to some embodiments of the present disclosure;

FIG. 6 is a block diagram illustrating an exemplary apparatus according to another embodiment of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow D2D communications to be implemented in a wireless communication network such as 4G/LTE or 5G/NR network. As used herein, D2D may be referred to in a broader sense to include communications between any types of UEs, and include V2X communications between a vehicle UE and any other type of UE. D2D and/or V2X may be a component of many existing wireless technologies when it comes to direct communication between wireless devices. D2D and/or V2X communications as an underlay to cellular networks may be proposed as an approach to take advantage of the proximity of devices.

3GPP specifies the LTE D2D technology, also known as SL or the PC5 interface, as part of Rel-12. The target use cases are the proximity services (communication and discovery). Support is enhanced during Rel-13. In Rel-14, the LTE SL is extensively redesigned to support vehicular communications (commonly referred to as V2X or V2V). Support is again enhanced during Rel-15. From the point of view of the lowest radio layers, the LTE SL uses broadcast communication. That is, transmission from a UE targets any receiver that is in range.

Proximity services (ProSe) are specified in Rel-12 and Rel-13 of LTE. Later in Rel-14 and Rel-15, LTE V2X related enhancements targeting the specific characteristics of vehicular communications are specified. In LTE V2X, only broadcast is supported over SL.

In Rel-16, 3GPP introduces the SL for 5G/NR communication systems. The driving use cases are vehicular communications with more stringent requirements than those typically served using the LTE SL. To meet these requirements, the NR SL is capable of broadcast, groupcast, and unicast communications. In groupcast communication, the intended receivers of a message are typically a subset of the vehicles near the transmitter, whereas in unicast communication, there is a single intended receiver.

Both the LTE SL and the NR SL can operate with and without network coverage and with varying degrees of interaction between the UEs and the network (NW), including support for standalone, network-less operation.

In Rel-17, 3GPP is working on enhancements for the NR SL. The ambition is not only to improve the capabilities of NR SL for V2X but also to address other use cases such as national security and public safety (NSPS) as well as commercial use cases such as network controlled interactive services (NCIS). In the future, the NR SL may be enhanced further to address other use cases too.

In 3GPP RAN started discussions in RAN #84 to identify the detailed motivations and work areas for NR SL enhancements in Rel-17. Significant interest has been observed on enhanced reliability and reduced latency, which allows the support of ultra-reliable and low latency communications (URLLC) type SL use cases in wider operation scenarios. The system level reliability and latency performance of SL is affected by the communication conditions such as the wireless channel status and the offered load, and Rel-16 NR SL is expected to have limitation in achieving high reliability and low latency in some conditions, e.g., when the channel is relatively busy. Solutions that can enhance reliability and reduce latency are required in order to keep providing the use cases requiring low latency and high reliability under such communication conditions.

SL CA is supported for V2X SL communication in LTE. For a TX UE using scheduled resource allocation (i.e., mode 3 in LTE and mode 1 in NR), the TX carrier is selected by a gNB and informed to the UE using downlink control information (DCI) format 5A along with carrier indicator field (CIF) which indicates the PC5 carrier to be used for physical sidelink shared channel (PSSCH) transmission. For a TX UE using autonomous resource selection (i.e., mode 4 in LTE and mode 2 in NR), the TX UE performs TX carrier selection by itself and may select one or more carriers for its V2X SL transmission, e.g., as described in 3GPP technical specification (TS) 36.321 V16.3.0. TX carrier (re-) selection may be triggered for a sidelink traffic channel (STCH, which is a sidelink logical channel carrying medium access control (MAC) control element (CE) or traffic from higher layer) and/or a carrier when any of the following conditions are met:
No configured SL grant on any carrier allowed for the STCH as indicated by upper layers.
The MAC entity selects to create a configured SL grant corresponding to transmissions of multiple MAC protocol data units (PDUs), data is available in STCH associated with one or multiple carriers, and the configured SL grant becomes invalid (i.e. resource reselection is triggered) in the carriers.
The MAC entity selects to create a configured SL grant corresponding to transmission(s) of a single MAC PDU, and data is available in STCH associated with one or multiple carriers.

If TX carrier (re-) selection is triggered, the MAC entity shall:
if there is no configured SL grant on any carrier allowed for the SL logical channel where data is available as indicated by upper layers (e.g. SL-AllowedCarrierFreqList as described in 3GPP TS 36.331 V16.3.0):
   for each carrier configured by upper layers associated with the concerned SL logical channel:
      if the channel busy ratio (CBR) of the carrier is below threshCBR-FreqReselection associated with the priority of the SL logical channel:
         consider the carrier as a candidate carrier for TX carrier (re-) selection for the concerned SL logical channel.
else:
   for each SL logical channel, if any, where data is available and that is allowed on the carrier for which TX carrier (re-) selection is triggered:
      if the CBR of the carrier is below threshCBR-FreqKeeping associated with priority of the SL logical channel:
         select the carrier and the associated pool of resources.
      else:
         for each carrier configured by upper layers on which the SL logical channel is allowed, if the CBR of the carrier is below threshCBR-FreqReselection associated with the priority of the SL logical channel;
         consider the carrier as a candidate carrier for TX carrier (re-) selection.

If one or more carriers are considered as the candidate carriers for TX carrier (re-) selection, the MAC entity shall:
for each SL logical channel allowed on the carrier where data is available and TX carrier (re-) selection is triggered:
   select one or more carrier(s) and associated pool(s) of resources among the candidate carriers with increasing order of CBR from the lowest CBR.

It may be left to UE implementation how many carriers to select based on UE capability.

Rel-18 work is currently under discussion in 3GPP and SL CA is considered as one of the first priority candidate topics for NR SL which is very likely to be considered in Rel-18. NR SL may support unicast (UC), groupcast (GC) and broadcast (BC) while LTE V2X SL may only support GC without any cyclic prefix (CP) signaling or lower layer feedback such as hybrid automatic repeat request (HARQ) feedback and channel state information (CSI) report from the receiver (RX) UE. Thus, simply applying TX carrier (re-) selection procedure introduced for LTE V2X SL may lead to sub-optimal performance for NR SL. Therefore, it may be desirable to study how to extend LTE SL CA framework for SL UC and develop corresponding solutions.

Various exemplary embodiments of the present disclosure propose solutions for SL TX carrier (re-) selection with multiple SL carriers, including when to perform the TX carrier (re-) selection and how to perform the TX carrier (re-) selection. By applying the proposed solutions, TX carrier (re-) selection may be performed, e.g., for NR SL when CA is supported. In many exemplary embodiments, the solutions are designed by taking into account the features introduced for NR SL (compared to those in LTE SL).

In accordance with an exemplary embodiment, there may be some conditions used to trigger TX carrier (re-) selection, which may consider the pool type, the number of carriers an STCH can be mapped on simultaneously and the performance in the carrier, while the performance may be assessed based on a transmission between a TX UE and a RX UE. In an embodiment, candidate TX carrier selection may be performed based on the performance which may be assessed based on the transmission between the TX UE and the RX UE. In another embodiment, the order of the (re-) selected TX carrier may be determined based on the performance which may be assessed based on the transmission between the TX UE and the RX UE.

In accordance with an exemplary embodiment, a TX UE in radio resource control (RRC) connected may inform some TX carrier related assistance information to a gNB. In an embodiment, the gNB may perform TX carrier (re-) selection based on the received assistance information. In accordance with another exemplary embodiment, the TX UE may send a message over SL to inform the RX UE of status related to TX carrier (re-) selection, based on which the RX UE can determine in which carrier(s) it may need to perform reception.

In accordance with an exemplary embodiment, the conditions and/or the performance metrics and/or the associated parameters may be configured differently for different STCHs and/or carriers and/or cast type.

Many advantages may be achieved by applying the proposed solutions. For example, the SL TX carrier (re-) selection can be performed more effectively, and the selected carrier(s) can provide a better performance than those selected according to the LTE mechanism, also the RX UE's power consumption may be reduced.

It can be appreciated that although some exemplary embodiments are described in the context of NR SL communications, various embodiments described in the present disclosure may be in general applicable to any kind of direct communications between UEs involving D2D communications such as LTE SL. Embodiments are described from a TX UE and RX UE point of view. In various embodiments of the present disclosure, it is assumed that the TX UE and the RX UE(s) are SL CA capable if not otherwise declared. Further, it is assumed that an SL UE and its serving gNB (if the UE is in NW coverage) may operate with the same radio access technology (RAT) e.g., NR, LTE, and so on. However, various embodiments described in the present disclosure may apply without any loss of meaning to any combination of RATs between the SL UE and its serving gNB.

It also can be appreciated that although some exemplary embodiments are described assuming TX carrier (re-) selection is performed per logical channel (LCH) and/or per carrier, various embodiments described in the present disclosure may be equally applied when TX carrier (re-) selection is performed per SL radio bearer or SL radio flow and/or per carrier.

In addition, it also can be appreciated that various embodiments described in the present disclosure may be applicable to SL transmission with any cast type including unicast, groupcast and broadcast unless otherwise stated.

In accordance with an exemplary embodiment, for a UE configured with SL CA, for each SL transmission between the UE pair, the UE may perform one of the following options to determine a suitable carrier among all configured SL carriers:
Option 1: select a carrier by the UE itself; and
Option 2: determine a carrier according to signaling/configuration provided by a gNB.

After that, the UE may obtain one or multiple SL grants associated with the determined SL carrier(s). The UE may further select destinations and LCHs to build one or multiple corresponding MAC PDUs to transmit using the SL grant(s).

In accordance with an exemplary embodiment, for a UE configured with SL CA, if the UE has data available for SL transmission (e.g., which may be sufficient for transmission of one or multiple MAC PDUs), the UE may trigger carrier selection and/or reselection (for a carrier and/or an SL LCH) when at least one of the following triggering conditions are met:
i). If there is no grant/resource available on any carrier.
   a grant may be a dynamic grant, a configured grant (e.g., configured grant Type 1 or configured grant Type 2), a grant obtained by the UE itself or a grant assigned or suggested by another UE (e.g., based on inter-UE coordination mechanism).
   a grant or resource may need to be associated with a specific HARQ process.
   the carrier may be one of the following:
      any carrier in the set of configured carriers for SL CA (and allowed for the SL LCH); and
      any active carrier in the set of configured carriers for SL CA (and allowed for the SL LCH).
ii). There is a grant available on a carrier, however the pool of resources where the grant is obtained is reconfigured by upper layers.
iii). The number of carriers with available grant/resource is less than the maximum number of carriers which the UE can use simultaneously for the SL transmission.
   the maximum number of carriers which the UE can use simultaneously for the SL transmission may be determined e.g., based on a specific UE capability bit, a configuration provided by the gNB or another UE, or a pre-configuration.
iv). For a SL carrier, the UE has been performing SL transmissions using the grants obtained via one of the following options:
   random resource selection; and
   sensing results provided by another UE.
   In this case, the UE may have no sensing requirement on the carrier. In an embodiment, the UE may trigger reselection to choose another carrier to replace this carrier.
v). For a SL carrier, measurement results or historic statistic indicate that the carrier is being congested or experiencing bad radio channel quality in terms of metrics, e.g., including reference signal received power (RSRP), reference signal received quality (RSRQ), received signal strength indicator (RSSI), signal to interference noise ratio (SINR), signal to interference ratio (SIR), channel busy ratio (CBR), channel occupancy ratio (CR), channel occupancy, listen before talk (LBT) failure statistics, HARQ negative acknowledgement (NACK) ratio, upper layer NACK ratio, etc.
   In an example, the number and/or the percentage of radio link control (RLC) NACK counted during a certain period exceeds an RLC NACK threshold in that carrier.
   In an example, the number and/or the percentage of HARQ NACK counted during a certain period exceeds a HARQ NACK threshold in that carrier.
   In an example, HARQ discontinuous transmission (DTX) is regarded as HARQ NACK if the MAC PDU is regarded as incorrectly received when HARQ DTX is detected, otherwise HARQ DTX is regarded as HARQ ACK.
   In an example, the (filtered) PC5 link quality to the RX UE is lower than a link quality threshold in that carrier.
      The TX UE may obtain the PC5 link quality in a carrier via e.g. an SL CSI report from the RX UE.
   The CBR keeps exceeding a CBR threshold during a certain period in that carrier.
vi). When no data/signaling is received during a certain period of time on a carrier.
vii). When signaling is sent on a carrier, but no response is received after expiration of a timer (e.g., the timer is started when the signaling is sent).
viii). For a SL carrier, the MAC entity selects to create a grant corresponding to transmission(s) of a single MAC PDU, and the last (re) transmission for a MAC PDU has been performed for a MAC PDU on that carrier.
ix). If the time difference between the set of resources obtained across the number of carriers exceeds the packet delay budget (PDB) or a predefined threshold.
   Both the PDB and the predefined threshold may be configured depending on the QOS requirement of the traffic carried on each carrier.

It can be appreciated that the triggering conditions being considered and/or the thresholds used in the triggering conditions may be different for different services or LCHs depending on e.g. the QoS requirement of the services or LCHs.

In accordance with an exemplary embodiment, according to one or more triggering conditions (e.g., one or more of the triggering conditions i)˜ix) as described previously), in the case that the carrier (re-) selection is triggered for one or more carriers, the UE may handle the carriers differently as in the following cases.
The UE may determine to continuously use a carrier which has already been selected. In other words, for the carrier, some triggering conditions for carrier reselection (e.g. one or more of the triggering conditions v) ˜ vii) as described previously) are not met.
The UE may determine to replace a carrier which has already been selected. In other words, for the carrier, some triggering conditions for carrier reselection (e.g. one or more of the triggering conditions v) ˜ vii) as described previously) are met. In this case, another carrier may be selected to replace the carrier.
The UE may select a set of candidate carriers, from which select one or more carriers to be used for the SL transmission.

It can be appreciated that the triggering conditions being considered in determining whether a selected carrier can be kept and/or whether a carrier can be considered as a candidate carrier and/or the thresholds used in the triggering conditions may be different for different LCHs depending on e.g. the QoS requirement associated with the LCHs.

In accordance with an exemplary embodiment, if one or more carriers are considered as the candidate carriers for an LCH in TX carrier (re-) selection, one or more carrier(s) and associated pool(s) of resources may be selected among the candidate carriers with a decreasing order of the priority associated with the carriers. In an embodiment, the priority of a carrier may be determined based on at least one of the following metrics:
Radio channel quality of the link on the carrier between the TX UE and the RX UE in terms of metrics, e.g., including RSRP, RSRQ, RSSI, SINR, SIR, HARQ NACK ratio, upper layer NACK ratio, etc.
   The PC5 link quality, e.g., higher the PC5 link quality is, higher priority of the carrier is determined.
   RLC NACK ratio of the link, e.g., lower NACK ratio is, higher priority of the carrier is determined.
   HARQ NACK ratio of the link, e.g., lower NACK ratio is, higher priority of the carrier is determined.
Frequency region of the carrier.
   In an embodiment, lower the carrier frequency is, higher priority of the carrier is determined.
   In another embodiment, higher the carrier frequency is, higher priority of the carrier is determined.
Congestion status of the link on the carrier between the TX UE and the RX UE in terms of metrics, e.g., including CBR, CR, channel occupancy, LBT failure statistics, etc.
   In an embodiment, lower the congestion is, higher priority of the carrier is determined.
A priority order signaled or configured by a gNB.
   This priority order may be determined based on the preference of the gNB.

In accordance with an exemplary embodiment, in the case that the UE has no statistics of the RLC NACK and/or the HARQ NACK on a carrier yet (e.g., the UE has not performed any SL transmission on the carrier), the UE may determine/obtain the statistics based on the transmission of the reverse link (e.g., the link from its peer UE to the UE).

In accordance with an exemplary embodiment, for a UE configured with SL CA, the UE may provide some assistance information to a gNB (e.g., via RRC signaling) containing at least one of the following information for one or multiple SL carriers:
Indices of the carriers or candidate carriers which the UE has selected.
Information on the LCHs/services/traffic types which have data available for SL transmission, e.g., including but not limited to:
   Identifier (ID) of each LCH.
   Data volume of each LCH.
   Corresponding destination (Layer-2, L2) ID of each LCH (multiple LCHs may be associated with the same destination).
Priority order associate with each carrier.
Indices of one or more carriers for which (re-) selection triggering conditions have been met.
Measurement results of each carrier in terms of metrics, e.g., including RSRP, RSRQ, RSSI, SINR, SIR, CBR, CR, channel occupancy, LBT failure statistics, HARQ NACK ratio, upper layer NACK ratio, etc.

In an embodiment, the assistance information may be reported to the gNB periodically. In this case, a periodic timer may be defined accordingly. As an example, the timer may be common to all carriers. Optionally, the UE may be configured with a separate timer for each carrier.

In another embodiment, the assistance information may be reported to the gNB in an event trigger fashion. For example, when certain triggering condition(s) (e.g., one or more of the triggering conditions i)˜ix) as described previously) are met, the UE may report to the gNB the information related to the concerned carriers which trigger the conditions.

In accordance with an exemplary embodiment, upon reception of signaling carrying assistance information from a UE, a gNB may provide signaling to the UE indicating one of the following:
confirming the (candidate) carriers that the UE has selected.
providing a (different) list of (candidate) carriers that the UE may need to select.
an indicator indicating that the UE may need to perform carrier (re-) selection by itself or need to follow the instruction from the gNB.
   In an embodiment, such indicator may be signaled per triggering condition(s). Therefore, there may be some triggering conditions based on which, the UE is allowed to perform carrier (re-) selection by itself; while there may be also some other triggering condition(s) based on which the UE may need to follow the instruction from the gNB.
   In another embodiment, such indicator may be signaled per LCH/service.
one or multiple triggering conditions for one or multiple carriers based on which, the UE can perform carrier selection and/or reselection.

According to an exemplary embodiment, in the case of Mode 1 resource allocation, the gNB may also signal at least one of the following information to the UE for its subsequent SL transmission:
one or multiple SL grants; and
one or multiple SL carriers.

In accordance with an exemplary embodiment, the conditions and/or the performance metrics and/or the associated parameters used by the UE and/or the gNB in the relevant procedures described in any embodiment may be configured in one or more of the following ways:
Configured differently for different LCHs depending on one or multiple of the following:
   QoS requirements associated with the LCH;
   whether RLC retransmission is enabled; and
   whether HARQ feedback is enabled.
Configured differently for different carriers depending on e.g. the frequency band of the carrier and/or whether the carrier is a licensed or unlicensed carrier.
Configured differently for different cast types, e.g. the conditions and/or the performance metrics requiring CSI report from the RX UE may not be considered for broadcast and groupcast, while the conditions and/or the performance metrics requiring HARQ feedback from the RX UE may not be considered for broadcast.

In accordance with an exemplary embodiment, the UE may inform a list of carriers allowed for an SL LCH as indicated by upper layers (e.g. SL-AllowedCarrierFreqList, etc.) to the peer UE so that they have aligned information on what carriers are allowed for the SL LCH. The peer UE or its serving gNB may accept or reject the configuration, and in the latter case, the UE may need to use the default carrier without CA enabled or the old list of carriers that has been agreed to be used. In an embodiment, the peer UE may only receive in the default carrier or the allowed carriers associated to LCH(s) that are configured between the UE and the peer UE.

In accordance with an exemplary embodiment, the UE may send a message to a peer UE over SL informing one or more of the following information:
Whether the UE is currently performing or going to perform carrier (re-) selection for certain SL LCH(s) carrying traffic transmitted towards the peer UE.
The carrier(s) that the UE selects for certain SL LCH(s) carrying traffic to be transmitted to the peer UE, which may be represented by a bitmap or index. The peer UE may obtain the selected carrier(s) based on the bitmap or index and the allowed carrier(s) for the associated SL LCH(s).

In accordance with an exemplary embodiment, upon reception of the information, the peer UE (i.e. RX UE) can prepare for reception of upcoming SL transmissions on the carriers which are indicated by the UE (i.e. TX UE). For instance, the RX UE may know from the message whether carrier (re-) selection is being performed or will soon be performed for certain SL LCH(s) by the TX UE. In an embodiment, the RX UE may know this by itself by judging e.g. whether one or more of triggering conditions (e.g., one or more of the triggering conditions i)˜ix) as described previously) are met for any carrier and SL LCH in which the TX UE transmits to the RX UE. In the case that the carrier (re-) selection is being performed or will soon be performed by the TX UE, the RX UE may receive in all the carrier(s) allowed for the SL LCH(s) for which the TX UE is (going to) perform carrier (re-) selection, otherwise the RX UE may only receive in the carrier(s) currently selected by the TX UE for its transmission to the destination.

In accordance with an exemplary embodiment, the TX UE may be configured by itself or a gNB or pre-configured to select a so-called first carrier (which has the highest priority) and a set of so-called second carriers (with lower priority). In an embodiment, the first carrier may be always used to communicate with the RX UE and can be configured in a static/semi-static manner. In another embodiment, the TX UE may inform the RX UE of information about the first carrier that is to be used and additionally or alternatively, inform the RX UE about the change in the corresponding first carrier, e.g. due to any of the triggering conditions i)˜ix) as described previously.

In accordance with an exemplary embodiment, the set of second carriers may not be mandatory to be used by the TX UE for communication with the RX UE and can be selected in a static/semi-static/dynamic manner. It can be appreciated that both the first/second carrier can either be in the licensed spectrum or the unlicensed spectrum.

In accordance with an exemplary embodiment, any signaling between a UE and a gNB may include at least one of the following signaling alternatives:
Common and/or dedicated RRC signaling;
MAC CE;
Paging message;
Control PDU of a protocol layer (e.g., service data adaptation protocol (SDAP), packet data convergence protocol (PDCP), RLC, or an adaptation layer in case of SL relay); and
Physical layer (L1) signaling on channels such as physical random access channel (PRACH), physical uplink control channel (PUCCH), physical downlink control channel (PDCCH), etc.

In accordance with an exemplary embodiment, any signaling between UEs may include at least one of the following signaling alternatives:
RRC signaling (e.g., PC5-RRC, etc.);
PC5-S signaling;
Discovery message;
MAC CE;
Control PDU of a protocol layer (e.g., SDAP, PDCP, RLC, or an adaptation layer in case of SL relay); and
L1 signaling on channels such as PSSCH, physical sidelink control channel (PSCCH), physical sidelink feedback channel (PSFCH), etc.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

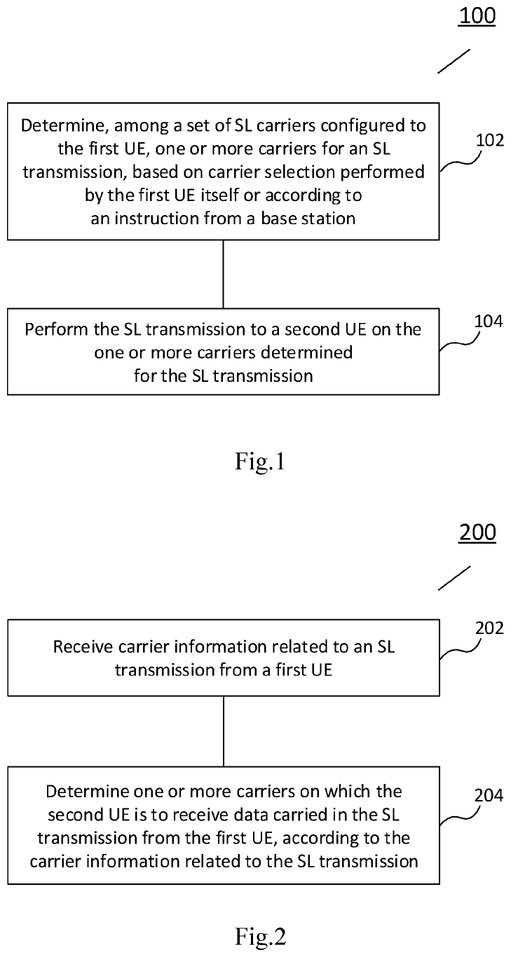

FIG. 1 is a flowchart illustrating a method 100 according to some embodiments of the present disclosure. The method 100 illustrated in FIG. 1 may be performed by a first UE or an apparatus communicatively coupled to the first UE. In accordance with an exemplary embodiment, the first UE may be configured to support D2D communication (e.g., V2X or SL communication, etc.) with other devices. In an exemplary embodiment, the first UE may be configured to communicate with a network node (e.g., a base station such as gNB, etc.) directly or via a relay UE.

According to the exemplary method 100 illustrated in FIG. 1, the first UE may determine, among a set of SL carriers configured to the first UE, one or more carriers for an SL transmission, based on carrier selection performed by the first UE itself or according to an instruction from a base station, as shown in block 102. In accordance with an exemplary embodiment, the first UE may perform the SL transmission to a second UE on the one or more carriers determined for the SL transmission, as shown in block 104.

In accordance with an exemplary embodiment, the carrier selection may be triggered for an SL carrier and/or an SL LCH, when one or more of the following triggering events occur:
there is no grant or resource available on any SL carrier allowed for the SL LCH;
there is a grant available on the SL carrier while a pool of resources where the grant is obtained is reconfigured by an upper layer;
the number of SL carriers with an available grant is less than the maximum number of SL carriers which the first UE can use simultaneously for the SL transmission;
a grant for the SL carrier is obtained according to random resource selection or a sensing result provided by another UE;
a measurement result or historic statistic of the SL carrier indicates that one or more metrics (e.g., RSRP, RSRQ, RSSI, SINR, SIR, CBR, CR, channel occupancy, LBT failure statistics, HARQ NACK ratio, upper layer NACK ratio, etc.) of the SL carrier do not meet one or more performance requirements;
no data or signaling is received during a first period of time on the SL carrier;
no response is received on the SL carrier within a second period of time after data or signaling is sent on the SL carrier;
the last transmission among one or more transmissions of a MAC PDU has been performed on the SL carrier for which a grant corresponding to the one or more transmissions of the MAC PDU is obtained; and
a time difference between resources obtained across a number of SL carriers exceeds a PDB or a predefined threshold.

In accordance with an exemplary embodiment, the triggering events, and/or metrics, parameters, thresholds and/or performance requirements associated with the triggering events may be configured differently for different services, different LCHs, different carriers, and/or different cast types, etc.

In accordance with an exemplary embodiment, when the carrier selection is triggered, the first UE may perform one or more of the following actions:
determining to continuously use one or more SL carriers which have already been selected;
determining to select one or more other SL carriers to replace one or more SL carriers which have already been selected; and
selecting one or more candidate carriers from the set of SL carriers configured to the first UE.

In accordance with an exemplary embodiment, the one or more carriers determined for the SL transmission may be selected by the first UE from the one or more candidate carriers according to a priority of the one or more candidate carriers.

In accordance with an exemplary embodiment, the priority of a candidate carrier may be determined based at least in part on one or more of:
channel quality of an SL between the first UE and the second UE on the candidate carrier;
a frequency region of the candidate carrier;
a congestion status of the SL between the first UE and the second UE on the candidate carrier; and
a priority order provided by the base station.

In accordance with an exemplary embodiment, the channel quality and/or the congestion status of the SL between the first UE and the second UE on the candidate carrier may be determined by the first UE based at least in part on: performance information of one or more SL transmissions from the first UE to the second UE on the candidate carrier, and/or performance information of one or more SL transmissions from the second UE to the first UE on the candidate carrier, etc.

In accordance with an exemplary embodiment, the first UE may transmit SL carrier related information to the base station. In an embodiment, the SL carrier related information may be transmitted to the base station periodically and/or in an event trigger fashion.

In accordance with an exemplary embodiment, the SL carrier related information may comprise one or more of:
one or more indices of one or more carriers and/or candidate carriers which the first UE has selected;
information about one or more LCHs and/or one or more services and/or one or more traffic types which have data available for the SL transmission;
one or more indices of one or more SL carriers for which one or more triggering events occur;
a priority order of the one or more SL carriers; and
measurement information of the one or more SL carriers.

In accordance with an exemplary embodiment, the first UE may receive carrier selection related information from the base station. In an embodiment, the carrier selection related information may be determined by the base station according to the SL carrier related information.

In accordance with an exemplary embodiment, the carrier selection related information may comprise one or more of:
a confirmation of one or more carriers and/or candidate carriers which the first UE has selected;
an instruction of that the first UE needs to select one or more carriers for the SL transmission from a list of carriers and/or candidate carriers provided by the base station;
an indicator indicating whether the first UE needs to perform the carrier selection by itself or follow the instruction from the base station; and
information indicating one or more triggering events for one or more carriers, where the first UE can perform the carrier selection based on the one or more indicated triggering events.

In accordance with an exemplary embodiment, the indicator may be received by the first UE per triggering event, per LCH or per service.

In accordance with an exemplary embodiment, the first UE may transmit carrier information related to the SL transmission to the second UE. In an embodiment, the carrier information related to the SL transmission may indicate a list of carriers allowed for an SL LCH of the SL transmission.

In accordance with an exemplary embodiment, the first UE may receive a message from the second UE. In an embodiment, the message may indicate whether the second UE accepts or refuses the list of carriers allowed for the SL LCH.

In accordance with an exemplary embodiment, when the message indicates that the second UE refuses the list of carriers allowed for the SL LCH, the first UE may use one or more default carriers or another list of carriers agreed by the first UE and the second UE for the SL LCH.

In accordance with an exemplary embodiment, the carrier information related to the SL transmission may comprise information about the carrier selection. In an embodiment, the information about the carrier selection may indicate one or more of:
whether the first UE is currently performing or going to perform the carrier selection for an SL LCH of the SL transmission; and
one or more carriers determined for the SL LCH by the first UE.

In accordance with an exemplary embodiment, the set of SL carriers configured to the first UE may include a first carrier. In an embodiment, the first carrier may have a highest priority among the set of SL carriers configured to the first UE, so that the first carrier may be preferred to be used for communication between the first UE and the second UE.

In accordance with an exemplary embodiment, the first UE may transmit information about the first carrier and/or a change of the first carrier to the second UE. In an embodiment, the first carrier may be selected in a static or semi-static manner.

In accordance with an exemplary embodiment, the set of SL carriers configured to the first UE may further include one or more second carriers. In an embodiment, compared to the first carrier, the one or more second carriers may have a lower priority and may not be mandatory to be used for the communication between the first UE and the second UE. In another embodiment, the one or more second carriers may be selected in a static, semi-static or dynamic manner.

FIG. 2 is a flowchart illustrating a method 200 according to some embodiments of the present disclosure. The method 200 illustrated in FIG. 2 may be performed by a second UE or an apparatus communicatively coupled to the second UE. In accordance with an exemplary embodiment, the second UE may be configured to support D2D communication (e.g., V2X or SL communication, etc.) with other devices. In an exemplary embodiment, the second UE may be configured to communicate with a network node (e.g., a base station such as gNB, etc.) directly or via a relay UE.

According to the exemplary method 200 illustrated in FIG. 2, the second UE may receive carrier information related to an SL transmission from a first UE (e.g., the first UE as described with respect to FIG. 1), as shown in block 202. According to the carrier information related to the SL transmission, the second UE may determine one or more carriers on which the second UE is to receive data carried in the SL transmission from the first UE, as shown in block 204.

In accordance with an exemplary embodiment, the carrier information related to the SL transmission may indicate a list of carriers allowed for an SL LCH of the SL transmission. In this case, the second UE may transmit a message to the first UE. In an embodiment, the message may indicate whether the second UE accepts or refuses the list of carriers allowed for the SL LCH.

In accordance with an exemplary embodiment, when the second UE accepts the list of carriers allowed for the SL LCH, the one or more carriers on which the second UE is to receive the data carried in the SL transmission from the first UE may be the list of carriers allowed for the SL LCH.

In accordance with an exemplary embodiment, when the second UE refuses the list of carriers allowed for the SL LCH, the one or more carriers on which the second UE is to receive the data carried in the SL transmission from the first UE may be one or more default carriers or another list of carriers agreed by the first UE and the second UE for the SL LCH.

In accordance with an exemplary embodiment, the carrier information related to the SL transmission may comprise information about carrier selection. In an embodiment, the information about the carrier selection may indicate whether the first UE is currently performing or going to perform the carrier selection for an SL LCH of the SL transmission. Alternatively or additionally, the information about the carrier selection may indicate one or more carriers determined for the SL LCH by the first UE.

In accordance with an exemplary embodiment, the second UE may determine whether the first UE is currently performing or going to perform the carrier selection for an SL LCH of the SL transmission, according to the information about the carrier selection and/or by determining whether one or more triggering events for any carrier occur for the SL LCH.

In accordance with an exemplary embodiment, when the second UE determines that the first UE is currently performing or going to perform the carrier selection for the SL LCH, the one or more carriers on which the second UE is to receive the data carried in the SL transmission from the first UE may be a list of carriers allowed for the SL LCH.

In accordance with an exemplary embodiment, when the second UE determines that the first UE is not performing or not going to perform the carrier selection for the SL LCH, the one or more carriers on which the second UE is to receive the data carried in the SL transmission from the first UE may be one or more carriers which are determined for the SL LCH by the first UE and indicated by the information about the carrier selection.

In accordance with an exemplary embodiment, the second UE may receive information about a first carrier and/or a change of the first carrier from the first UE. In an embodiment, the first carrier may have a highest priority among a set of SL carriers configured to the first UE, so that the first carrier may be preferred to be used for communication between the first UE and the second UE.

In accordance with an exemplary embodiment, the set of SL carriers configured to the first UE may further include one or more second carriers, in addition to the first carrier. In an embodiment, compared to the first carrier, the one or more second carriers may have a lower priority and may not be mandatory to be used for the communication between the first UE and the second UE.

In accordance with an exemplary embodiment, the first carrier may be selected in a static or semi-static manner. In accordance with another exemplary embodiment, the one or more second carriers may be selected in a static, semi-static or dynamic manner.

It can be appreciated that the first UE as described with respect to FIG. 1 may also be configured to perform the method 200 as described with respect to FIG. 2, according to different application scenarios and service requirements. Similarly, it can be appreciated that the second UE as described with respect to FIG. 2 may also be configured to perform the method 100 as described with respect to FIG. 1, according to different application scenarios and service requirements.

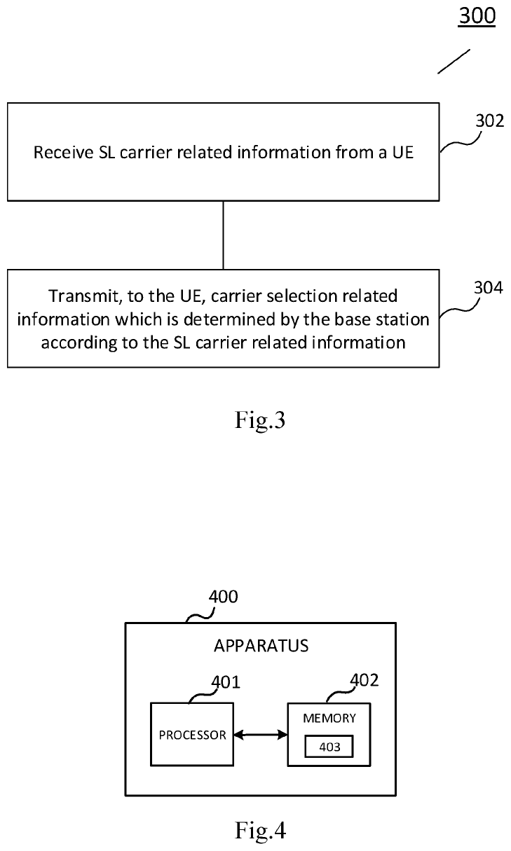

FIG. 3 is a flowchart illustrating a method 300 according to some embodiments of the present disclosure. The method 300 illustrated in FIG. 3 may be performed by a base station (e.g., a gNB, an AP, etc.) or an apparatus communicatively coupled to the base station. In accordance with an exemplary embodiment, the base station may be configured to support cellular coverage extension with D2D communication (e.g., V2X or SL communication, etc.). In an exemplary embodiment, the base station may be configured to communicate with a terminal device such as a UE, e.g. directly or via a relay UE.

According to the exemplary method 300 illustrated in FIG. 3, the base station may receive SL carrier related information from a UE (e.g., the first UE as described with respect to FIG. 1 or the second UE as described with respect to FIG. 2), as shown in block 302. For example, the SL carrier related information may be received by the base station periodically and/or in an event trigger fashion. In accordance with an exemplary embodiment, the base station may transmit, to the UE, carrier selection related information which is determined by the base station according to the SL carrier related information, as shown in block 304. In an embodiment, the carrier selection related information may be used by the UE to determine, among a set of SL carriers configured to the UE, one or more carriers for an SL transmission.

In accordance with an exemplary embodiment, the SL carrier related information may comprise one or more of: one or more indices of one or more carriers and/or candidate carriers which the UE has selected; information about one or more LCHs and/or one or more services and/or one or more traffic types which have data available for the SL transmission; one or more indices of one or more SL carriers for which one or more triggering events occur; a priority order of the one or more SL carriers; and measurement information of the one or more SL carriers, etc.

In accordance with an exemplary embodiment, the carrier selection related information may comprise one or more of: a confirmation of one or more carriers and/or candidate carriers which the UE has selected; an instruction of that the UE needs to select one or more carriers for the SL transmission from a list of carriers and/or candidate carriers provided by the base station; an indicator indicating whether the UE needs to perform the carrier selection by itself or follow the instruction from the base station; and information indicating one or more triggering events for one or more carriers, where the UE can perform the carrier selection based on the one or more indicated triggering events.

In accordance with an exemplary embodiment, the indicator indicating whether the UE needs to perform the carrier selection by itself or follow the instruction from the base station may be transmitted to the UE by the base station per triggering event, per LCH or per service.

The various blocks shown in FIGS. 1-3 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

FIG. 4 is a block diagram illustrating an apparatus 400 according to various embodiments of the present disclosure. As shown in FIG. 4, the apparatus 400 may comprise one or more processors such as processor 401 and one or more memories such as memory 402 storing computer program codes 403. The memory 402 may be non-transitory machine/processor/computer readable storage medium. In accordance with some exemplary embodiments, the apparatus 400 may be implemented as an integrated circuit chip or module that can be plugged or installed into a first UE as described with respect to FIG. 1, a second UE as described with respect to FIG. 2, or a base station as described with respect to FIG. 3. In such cases, the apparatus 400 may be implemented as a first UE as described with respect to FIG. 1, a second UE as described with respect to FIG. 2, or a base station as described with respect to FIG. 3.

In some implementations, the one or more memories 402 and the computer program codes 403 may be configured to, with the one or more processors 401, cause the apparatus 400 at least to perform any operation of the method as described in connection with FIG. 1. In other implementations, the one or more memories 402 and the computer program codes 403 may be configured to, with the one or more processors 401, cause the apparatus 400 at least to perform any operation of the method as described in connection with FIG. 2. In other implementations, the one or more memories 402 and the computer program codes 403 may be configured to, with the one or more processors 401, cause the apparatus 400 at least to perform any operation of the method as described in connection with FIG. 3. Alternatively or additionally, the one or more memories 402 and the computer program codes 403 may be configured to, with the one or more processors 401, cause the apparatus 400 at least to perform more or less operations to implement the proposed methods according to the exemplary embodiments of the present disclosure.

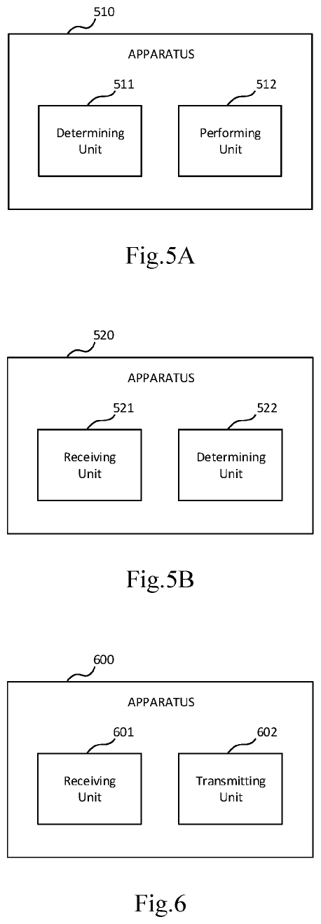

FIG. 5A is a block diagram illustrating an apparatus 510 according to some embodiments of the present disclosure. As shown in FIG. 5A, the apparatus 510 may comprise a determining unit 511 and a performing unit 512. In an exemplary embodiment, the apparatus 510 may be implemented in a first UE. The determining unit 511 may be operable to carry out the operation in block 102, and the performing unit 512 may be operable to carry out the operation in block 104. Optionally, the determining unit 511 and/or the performing unit 512 may be operable to carry out more or less operations to implement the proposed methods according to the exemplary embodiments of the present disclosure.

FIG. 5B is a block diagram illustrating an apparatus 520 according to some embodiments of the present disclosure. As shown in FIG. 5B, the apparatus 520 may comprise a receiving unit 521 and a determining unit 522. In an exemplary embodiment, the apparatus 520 may be implemented in a second UE. The receiving unit 521 may be operable to carry out the operation in block 202, and the determining unit 522 may be operable to carry out the operation in block 204. Optionally, the receiving unit 521 and/or the determining unit 522 may be operable to carry out more or less operations to implement the proposed methods according to the exemplary embodiments of the present disclosure.

FIG. 6 is a block diagram illustrating an apparatus 600 according to some embodiments of the present disclosure. As shown in FIG. 6, the apparatus 600 may comprise a receiving unit 601 and a transmitting unit 602. In an exemplary embodiment, the apparatus 600 may be implemented in a base station (e.g., a gNB, an AP, etc.). The receiving unit 601 may be operable to carry out the operation in block 302, and the transmitting unit 602 may be operable to carry out the operation in block 304. Optionally, the receiving unit 601 and/or the transmitting unit 602 may be operable to carry out more or less operations to implement the proposed methods according to the exemplary embodiments of the present disclosure.

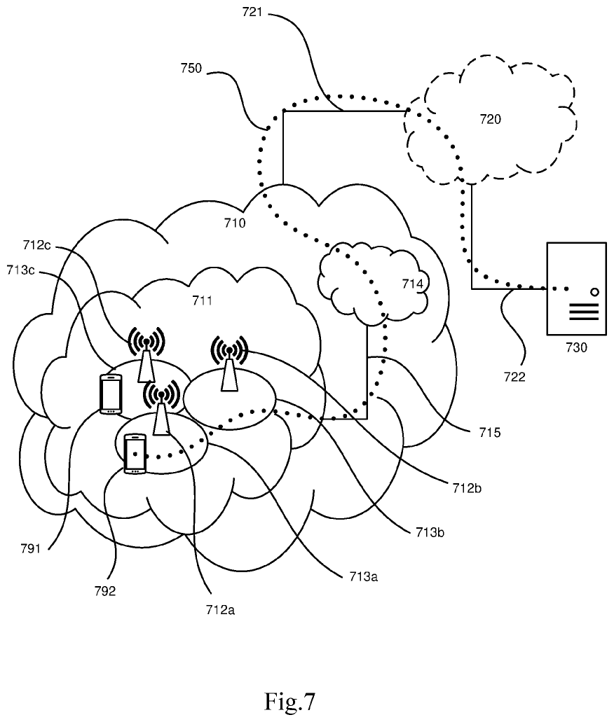

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

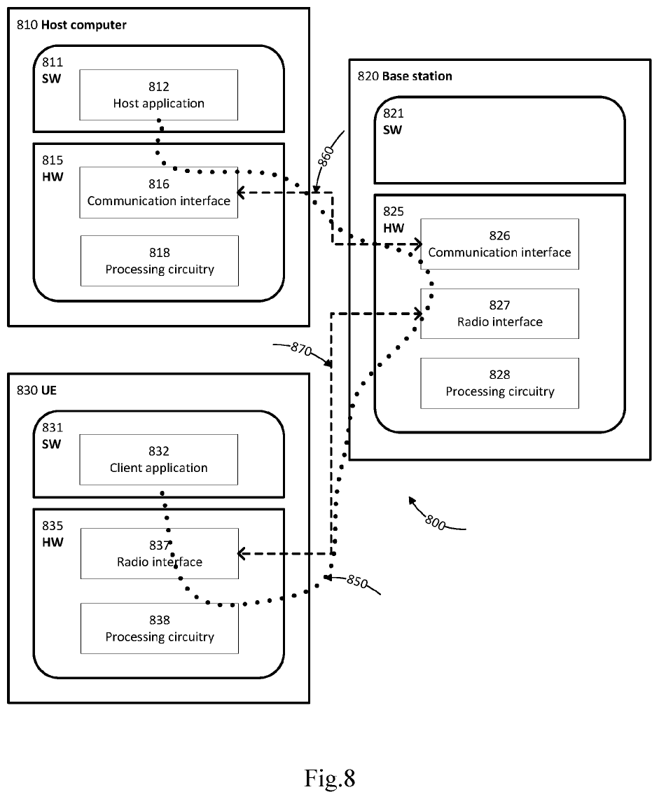

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

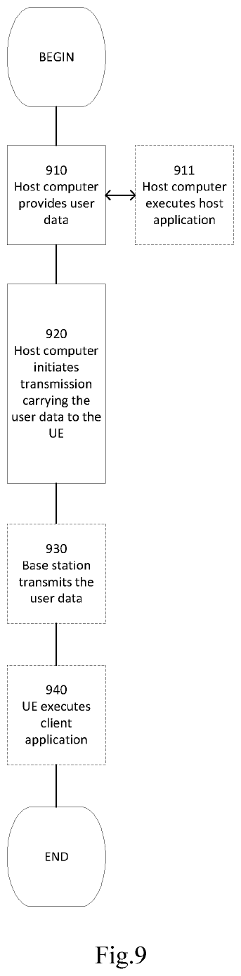

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

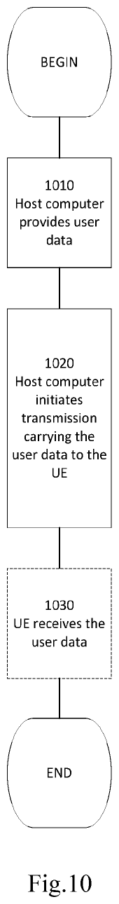

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

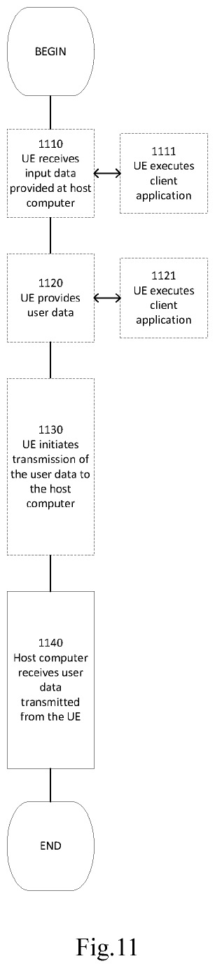

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

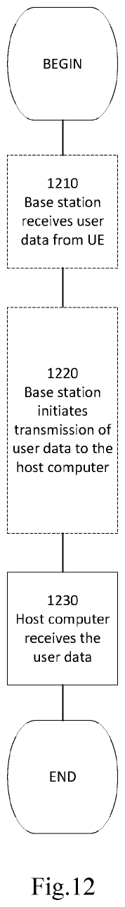

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 300 as described with respect to FIG. 3.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 300 as described with respect to FIG. 3.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 100 as described with respect to FIG. 1, or any step of the exemplary method 200 as described with respect to FIG. 2.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 100 as described with respect to FIG. 1, or any step of the exemplary method 200 as described with respect to FIG. 2.

According to some exemplary embodiments, there is provided a method implemented in a communication system which may include a host computer, a base station and a UE. The method may comprise, at the host computer, receiving user data transmitted to the base station from the UE which may perform any step of the exemplary method 100 as described with respect to FIG. 1, or any step of the exemplary method 200 as described with respect to FIG. 2.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 100 as described with respect to FIG. 1, or any step of the exemplary method 200 as described with respect to FIG. 2.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 300 as described with respect to FIG. 3.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 300 as described with respect to FIG. 3.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method performed by a first user equipment, UE, comprising:
determining, among a set of sidelink, SL, carriers configured to the first UE, one or more carriers for an SL transmission, based on carrier selection performed by the first UE itself or according to an instruction from a base station; and
performing the SL transmission to a second UE on the one or more carriers determined for the SL transmission.

2. The method according to claim 1, wherein the carrier selection is triggered for an SL carrier and/or an SL logical channel, LCH, when one or more of the following triggering events occur:
there is no grant or resource available on any SL carrier allowed for the SL LCH;
there is a grant available on the SL carrier while a pool of resources where the grant is obtained is reconfigured by an upper layer;
a number of SL carriers with an available grant is less than a maximum number of SL carriers which the first UE is able to use simultaneously for the SL transmission;
a grant for the SL carrier is obtained according to random resource selection or a sensing result provided by another UE;
a measurement result or historic statistic of the SL carrier indicates that one or more metrics of the SL carrier do not meet one or more performance requirements;
no data or signaling is received during a first period of time on the SL carrier;
no response is received on the SL carrier within a second period of time after data or signaling is sent on the SL carrier;
a last transmission among one or more transmissions of a medium access control, MAC, protocol data unit, PDU, has been performed on the SL carrier for which a grant corresponding to the one or more transmissions of the MAC PDU is obtained; and
a time difference between resources obtained across a number of SL carriers exceeds a packet delay budget, PDB or a predefined threshold.

3. The method according to claim 2, wherein the triggering events, and/or metrics, parameters, thresholds and/or performance requirements associated with the triggering events are configured differently for:
different services;
different LCHs;
different carriers; and/or
different cast types.

4. The method according to claim 1, wherein when the carrier selection is triggered, the method further comprises one or more of:
determining to continuously use one or more SL carriers which have already been selected;
determining to select one or more other SL carriers to replace one or more SL carriers which have already been selected; and
selecting one or more candidate carriers from the set of SL carriers configured to the first UE.

5.-7. (canceled)

8. The method according to claim 1, further comprising:
transmitting SL carrier related information to the base station.

9. The method according to claim 8, wherein the SL carrier related information comprises one or more of:
one or more indices of one or more carriers and/or candidate carriers which the first UE has selected;
information about one or more LCHs and/or one or more services and/or one or more traffic types which have data available for the SL transmission;
one or more indices of one or more SL carriers for which one or more triggering events occur;
a priority order of the one or more SL carriers; and
measurement information of the one or more SL carriers.

10. The method according to claim 8, wherein the SL carrier related information is transmitted to the base station periodically and/or in an event trigger fashion.

11. The method according to claim 8, further comprising:
receiving carrier selection related information from the base station, wherein the carrier selection related information is determined by the base station according to the SL carrier related information.

12. The method according to claim 11, wherein the carrier selection related information comprises one or more of:
a confirmation of one or more carriers and/or candidate carriers which the first UE has selected;
an instruction of that the first UE needs to select one or more carriers for the SL transmission from a list of carriers and/or candidate carriers provided by the base station;
an indicator indicating whether the first UE needs to perform the carrier selection by itself or follow the instruction from the base station; and
information indicating one or more triggering events for one or more carriers, wherein the first UE is able to perform the carrier selection based on the one or more indicated triggering events.

13. The method according to claim 12, wherein the indicator is received by the first UE per triggering event, per LCH or per service.

14. The method according to claim 1, further comprising:
transmitting carrier information related to the SL transmission to the second UE.

15. The method according to claim 14, wherein the carrier information related to the SL transmission indicates a list of carriers allowed for an SL LCH of the SL transmission, and the method further comprises:
receiving a message from the second UE, wherein the message indicates whether the second UE accepts or refuses the list of carriers allowed for the SL LCH.

16. The method according to claim 15, wherein when the message indicates that the second UE refuses the list of carriers allowed for the SL LCH, the method further comprises:
using one or more default carriers or another list of carriers agreed by the first UE and the second UE for the SL LCH.

17. The method according to claim 14, wherein the carrier information related to the SL transmission comprises information about the carrier selection.

18. The method according to claim 17, wherein the information about the carrier selection indicates one or more of:
whether the first UE is currently performing or going to perform the carrier selection for an SL LCH of the SL transmission; and
one or more carriers determined for the SL LCH by the first UE.

19. The method according to claim 1, wherein the set of SL carriers configured to the first UE includes a first carrier, and the first carrier has a highest priority among the set of SL carriers configured to the first UE, so that the first carrier is preferred to be used for communication between the first UE and the second UE.

20. The method according to claim 19, wherein the first carrier is selected in a static or semi-static manner.

21. The method according to claim 19, further comprising:
transmitting information about the first carrier and/or a change of the first carrier to the second UE.

22.-26. (canceled)

27. A method performed by a second user equipment, UE, comprising:
receiving carrier information related to a sidelink, SL, transmission from a first UE; and
determining one or more carriers on which the second UE is to receive data carried in the SL transmission from the first UE, according to the carrier information related to the SL transmission.

28.-42. (canceled)

43. A method performed by a base station, comprising:
receiving sidelink, SL, carrier related information from a user equipment, UE; and
transmitting, to the UE, carrier selection related information which is determined by the base station according to the SL carrier related information, wherein the carrier selection related information is used by the UE to determine, among a set of SL carriers configured to the UE, one or more carriers for an SL transmission.

44.-50. (canceled)
